(19) United States
(12) Patent Application Publication
(10) Pub. No.: US 2026/0119376 A1
(43) Pub. Date: Apr. 30, 2026

(54) PERFORMING CODE REVIEW AND GENERATION OF TEST SCENARIOS USING INTEGRATED PROGRAMMATIC AND SPECIALIZED GUIDED AND CONSTRAINED ARTIFICIAL INTELLIGENCE

(71) Applicant: Skyvera, LLC, Austin, TX (US)

(72) Inventors: Arthur Michel, Brooklyn, NY (US); Alexander Eppstein, Unterhaching Germany (DE); Colin Guilfoyle, Drogheda (IE)

(73) Assignee: Skyvera, LLC, Austin, TX (US)

(21) Appl. No.: 19/369,068

(22) Filed: Oct. 24, 2025

Related U.S. Application Data
(60) Provisional application No. 63/711,694, filed on Oct. 24, 2024.
(60) Provisional application No. 63/711,696, filed on Oct. 24, 2024.
(60) Provisional application No. 63/711,698, filed on Oct. 24, 2024.

(51) Int. Cl. G06F 11/3668; G06F 8/71; G06F 8/73

(52) U.S. Cl. CPC G06F 11/3684; G06F 8/71; G06F 8/73

(57) ABSTRACT

A code management system and method for guiding the AI engine to generate code review comments and test scenarios is disclosed. The code review comments and test scenario generation involve the generation of merge requests by the user on the user interface of the version control system. The database stores the merge request details. The code automation system fetches the merge request details and populates the prompt structure. The prompt generator generates prompts to guide the AI engine to generate code review comments and test scenarios using machine learning algorithms.

### CROSS-REFERENCE TO RELATED APPLICATION(S)

This application claims the benefit under 35 U.S.C. § 119(e) and 37 C.F.R. § 1.78 of U.S. Provisional Application Nos. 63/711,694, 63/711,696, and 63/711,698, which are incorporated by reference in their entireties.

This application incorporates U.S. patent application Ser. No. 19/369,061 by reference in its entirety.

### FIELD OF THE INVENTION

The present invention relates in general to the field of electronics, and more specifically to code management systems and code management processes to perform code review comments and generate test scenarios.

### BACKGROUND

Software development is the process of creating, testing, and maintaining software, a set of instructions that tells a computer system how to perform tasks. The software development involves programming and maintaining the source code, research, design, testing, and debugging. Code review is a quality assurance process and is a part of the software development cycle. The code review examines the source code for bugs, improves code quality, and ensures adherence to coding standards. Traditionally, the codes are reviewed by human reviewers who manually inspect code for errors, adherence to coding standards, and other quality metrics. While human reviewers can identify potential bugs, logical errors, and design flaws, human reviewers can miss subtle issues or make errors, especially in complex codebases. The human reviewers ensure consistent coding standards and best practices making the code easier to understand, however, different reviewers may have varying standards and expertise leading to inconsistent code quality assessments. Although the human reviewers enhance the code quality, manual reviewing can be a time-intensive process potentially slowing the code development process. The conventional automated code review tools analyze code for quality issues, security vulnerabilities, and coding standards. While the conventional automated code review tools help to identify and fix code quality issues. However, the conventional automated code review generates false positive results.

Also, test scenarios generation is a key part of software development. The test scenario generation ensures the software works as expected from the user perspective. The test scenario aims to cover various use cases, including edge cases to ensure that the software behaves as expected. Traditionally the test scenario generation is handled by quality assurance engineers who devise test scenarios based on their understanding of the code and its requirements. The human-driven test planning is exhaustive with experienced developers providing insights based on a deep understanding of the code and application. While human-driven test planning can be detailed, the manual creation of test scenarios is time-consuming and prone to errors. The conventional automated test scenario generation tools automate the generation of test scripts. While the conventional automated test scenario generation tools support multiple programming languages and community support, they might not adapt to dynamic elements and complex setups.

### BRIEF DESCRIPTION OF THE DRAWINGS

The systems and methods described herein may be better understood, and their numerous objects, features, and advantages made apparent to those skilled in the art by referencing exemplary embodiments depicted in the accompanying figures. The use of the same reference number throughout the several figures designates a like or similar element.

FIG. 1 depicts an exemplary code management system for performing code review comments and generating test scenarios.

FIG. 2 depicts an exemplary code management process utilized by the code management system.

FIG. 3 depicts an exemplary review comment and test scenario generation process, which is an embodiment of the code management process of FIG. 2.

FIG. 4 depicts a sequence diagram to display results on a user interface of a version control system.

FIG. 5 depicts a data structure for providing details of the merge request for code review comments and test scenario generation.

FIG. 6 depicts a data structure to store the details of the AI-generated review comments during the code review process.

FIG. 7 depicts a data structure to store the details of AI-generated test scenarios.

FIG. 8 depicts an exemplary network environment in which the system of FIG. 1 and the process of FIG. 2 may be practiced.

FIG. 9 depicts an exemplary computer system.

### DETAILED DESCRIPTION

The system and method to guide the Artificial Engine (AI) engine to generate code review comments and test scenarios for changes in the code. The system and method involve the generation of merge requests by the user on a version control system. The database is operatively coupled to the version control system to store the merge request details generated by the user. The code automation system fetches the details of the merge request via an API. The prompt generator generates prompts to guide the AI engine to generate code review comments and test scenarios.

The AI engine analyzes the prompts generated by the prompt generator. The AI engine checks the code for potential issues and security vulnerabilities, performs code review comments, and generates test scenarios. The AI engine utilizes machine learning algorithms to learn from past data and generates code review comments and test scenarios.

The automated code review of the merge requests helps discern potential problems early in the development cycle and improves code quality. Moreover, the code management system orchestrates the execution of tasks such as code review and test scenario generation in a sequential manner using the GitlabMergeRequestReviewCrew class. This structured approach ensures that each step is completed systematically before moving on to the next, maintaining a clear and organized workflow.

The system and method set forth herein address technical issues with generating the desired outputs described herein. Conventionally, manual processes were used to generate the desired outputs and were very tedious and time consuming. The present system and method utilize an automated system that does not merely automate a manual process or use a conventional system in a conventional way. The present system and method utilize one or more artificial intelligence (AI) engines and integrate programmatic process management to technologically guide and constrain the one or more AI engines to produce the desired outputs in a completely different way than any manual process and different than normal use of programs and AI engines. Utilizing specially engineered guidance and control to direct an AI system to solve the problems below presents a technical problem that requires a technical solution. The system and method described below are not simply engaging a computer to carry out conventional mental processes, but rather change how computers (and AI systems, specifically) operate to achieve the generation results that were not previously possible or were substantially inefficient prior to the system and method set forth below. The AI system needs specific technical guidance, control, and constraints to achieve results that are not otherwise achievable.

Prompts are used to guide and constrain each AI engine. The prompts guide each AI engine by steering the AI engine(s). “Guiding” an AI engine refers to providing the AI engine with a general direction or framework to shape the AI engine's behavior or decision-making process. Guiding sets goals or principles. Guiding allows the AI engine some flexibility to interpret and adapt, much like giving it a compass to navigate rather than a fixed path.

Constraining each AI engine includes imposing specific, hard limits or rules on what each AI engine can do. Constraining an AI engine can also include providing specific input data to not only guide but also constrain the scope of each AI engine's reasoning basis and response. Constraining each AI engine assists with aligning the AI engine(s) for its (their) intended use.

Normally AI engines are provided a single user prompt requesting the AI engine, such as OpenAI's ChatGPT and its various implementations such as Anthropic's Claude Sonnet, to perform a task and produce an output. However, this conventional AI engine prompting method has a variety of technical shortcomings. Without proper guidance and constraints, an AI engine will not produce the desired output specified as produced by the system and method described herein. Instead, the AI engine will produce many unusable outputs that are unusable for a variety of reasons including so-called “hallucinations” where the AI engine presents fabricated information, duplicate outputs, too few outputs, too many outputs, outputs that do not meet desired criteria, and so on. Without special technical guidance, the AI engine cannot reliably be applied to generate desired outcomes.

The system and method generate decomposed, technically engineered AI prompts to include selected and integral AI engine guidance and constraints. Conventional approaches often do not recognize the technical capabilities of an engineered prompt to guide and constrain an AI engine to generate a desired output. The technically engineered prompts are generated and guided with programmatic, automatic inputs specifically designed to unconventionally guide and constrain an AI engine to produce desired outputs, perform quality control to retain or automatically discard outputs that do not meet guidance and constraints, and make the desired outputs available for use, such as use by computer system applications. In at least one embodiment, the problem to be solved by the integrated programmatic and AI engine system and method is uniquely and unconventionally decomposed, and AI prompts are used to solve the decomposed problem. Furthermore, the programmatic inputs to the decomposed AI prompts provide guidance to meet desired output characteristics.

Determining a number of prompts, the guidance and constraints within each prompt, and data flowing from one AI engine prompt to another, in addition to testing a number of prompts for the decomposed problem, testing within each prompt, and validating a desired quality of outputs becomes an intractable combinatorial problem without technical guidance and constraint of the system and method described herein. Thus, the present system and method described implement an integration of programmatic management over decomposed prompts with engineered AI engine guidance and constraints to effect an improvement in AI, programmatic AI management, and AI integrated with programmatic management technology. The present system and method allow computer systems to include programmatic management, one or more AI engines, and one or more data sources to produce the output described herein that previously could not be produced with conventionally prompted AI engines or could only be produced by humans utilizing a completely different, time consuming, and tedious process. The system and method improve conventional methods through the use of a programmatic AI engine management system to generate decomposed, technically engineered AI prompts to include selected and integral AI engine guidance and constraints. It is, for example, the incorporation of the programmatic AI engine management system to generate decomposed, technically engineered AI prompts to include generated, integral, and unconventional AI engine guidance and constraints and execution by the one or more AI engines to provide useful results that improve existing technical processes, which is not an automation of a conventional process.

Programmatic components and AI engines generally utilize one or more processors that have access to memory, which may include one or more storage components, to execute and perform functions. An AI engine is a core hardware and software system that enables artificial intelligence applications to process data, learn patterns, and generate insights or actions. It functions as the brain behind AI-driven systems, facilitating tasks such as machine learning, natural language processing, and decision-making. Exemplary components of an AI engine are:
1. Machine Learning Models—Algorithms that analyze data, recognize patterns, and make predictions.
2. Neural Networks—Deep learning architectures that mimic the human brain for tasks like image and speech recognition.
3. Data Processing Module—Handles raw data input, transformation, and feature extraction.
4. Inference Engine—Applies trained models to make real-time decisions based on new data.
5. Optimization Algorithms—Improves model efficiency, reducing errors and improving predictions.
6. Natural Language Processing (NLP) Module—Enables AI engines to understand, interpret, and generate human language (e.g., chatbots, voice assistants).
7. Computer Vision Module—Allows AI to interpret and analyze images or videos.
8. Reinforcement Learning Mechanism—Helps AI learn from trial and error, optimizing performance over time.
9. API Interface—Connects the AI engine with applications, enabling integration with other software or platforms.

Examples of AI Engines include: XAI's Grok and variations thereof, Google TensorFlow, Meta's PyTorch, Microsoft Azure AI, OpenAI's ChatGPT and variations thereof, IBM Watson, OpenAI Whisper, Google BERT & T5, Amazon Lex, Anthropic Claude, DeepMind's AlphaCode, Google Vision AI, Meta's DINO & SAM (Segment Anything Model), NVIDIA DeepStream. OpenCV AI Kit, Amazon Polly. Google WaveNet, Deepgram.

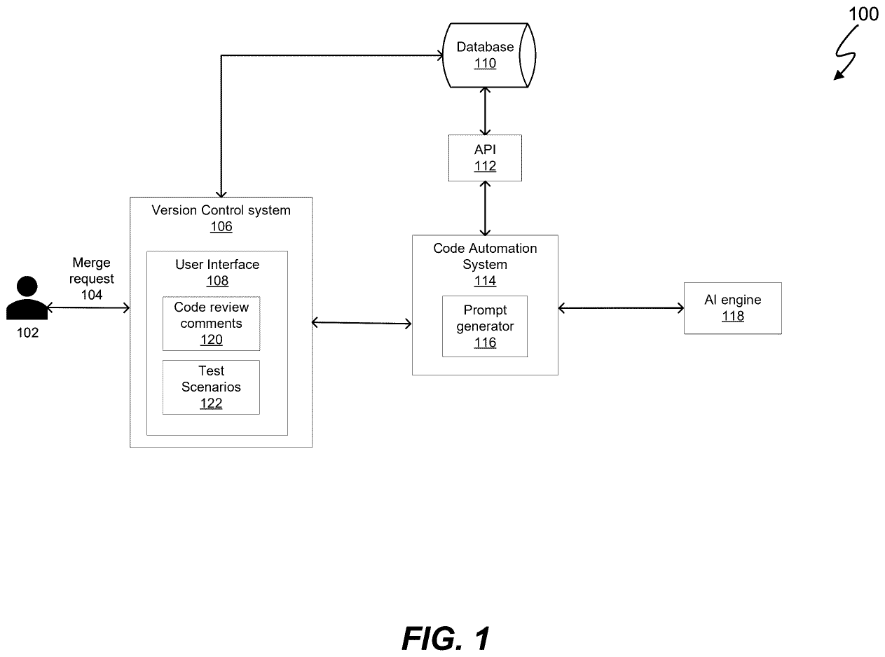

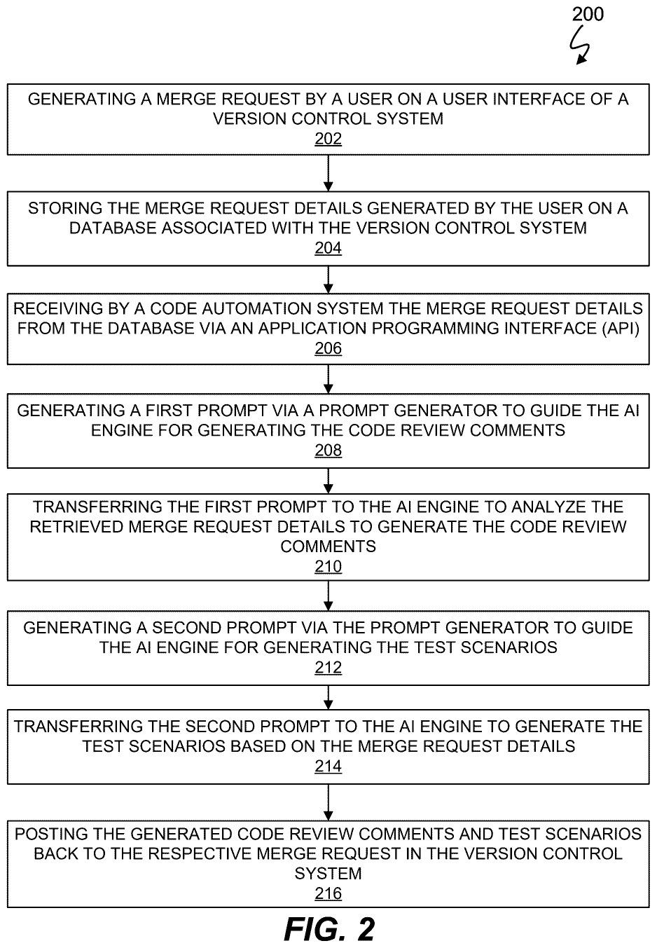

FIG. 1 depicts an exemplary code management system 100 for performing code review comments 120 and generating test scenarios 122. FIG. 2 depicts an exemplary code management process 200 utilized by the system 100.

The Artificial Intelligence (AI) 118 is designed to streamline and optimize the process of performing code review comments 120 and generating test scenarios 122. The AI engine 118 performs code review comments 120, such as identifying potential issues, providing insights into code quality, and assisting in generating test scenarios 122. The AI engine 118 can be triggered by analyzing the code for common programming errors, adherence to coding standards, and potential performance bottlenecks. The AI engine 118 can parse the code to identify patterns, anomalies, and potential improvements. When triggered, the AI engine 118 can provide automated suggestions for code improvements, detect potential security vulnerabilities, and offer insights. During the generation of test scenarios 122, the AI engine 118 can be triggered to analyze code and automatically generate test cases based on criteria such as code coverage, boundary value analysis, and equivalence partitioning. By understanding the code structure and behavior, the AI engine 118 can generate test scenarios 122 that help ensure comprehensive test coverage and efficient testing. The AI engine 118 can be triggered by specific events or actions, such as when a code review comments 120 is initiated. For example, the AI engine 118 can automatically analyze the code and provide feedback in real time, allowing for faster iteration and improved code quality.

In operation 202, user 102 generates a merge request 104 on an user interface 108 of a version control system 106. The merge request 104 includes merge request details which includes details of commit messages, file content, and diffs.

The user 102 generates the merge request 104 to merge code from one branch to another branch on the user interface 108 of the version control system 106. The user interface 108 is integrated into the version control system 106. The user 102 interacts with the version control system 106 via the user interface 108. The code refers to the set of instructions written in a programming language for a computer system such as desktops, laptops, smartphones and so forth that can be executed to perform specific tasks. The different programming languages employed for writing the code by the user 102, include Javascript, Python, C# and the like. The codes are prepared to ensure that the software or a program works efficiently. The codes are configured to establish the scope of working of the program or the software. Typically, the code is configured to define what a program does, how it does, and how an end user can interact with the program or the software. The end user can be either a developer, a tester, or an administrator. The user 102 provides a layout for the codes. The users 102 can be software developers, engineers, and programmers who are utilizing the user interface 108 of the version control system 106. For example, a user 102 such as ‘Sarah’ a web developer works on a project to build a new e-commerce website. Sarah writes the code for the site to implement features like product listing and shopping cart functionality.

Typically, the version control systems 106 including Git, GitHub, GitLab and the like help to manage the changes to the code and facilitate collaboration among the user(s) 102. Typically, Git is an open-source version control tool maintained by the Linux Foundation. GitHub and GitLab is a code-repository service for the user 102. GitHub is owned by Microsoft having headquarters in California and GitLab is owned by GitLab Inc having headquarters in California. Moreover, various tools can be utilized to assist the user 102 such as software developers, engineers, and programmers in the coding process. In at least one of the embodiments, the user 102 can utilize Integrated Development Environments (IDEs), Testing Frameworks, and Deployment Tools for the generation of codes.

The user 102 commits changes on the user interface 108 in the code to implement new features within the ongoing project. The new features include addition, deletion, or alterations to be made in the code of the ongoing project. The user 102 can commit changes in a branch of the code on the user interface 108. The branch is a separate line of code within the project. The branch allows the user 102 to commit changes independently of the main codebase often known as the master branch. The branch where the commit takes place is known as the source branch and the branch where the changes are merged is known as the target branch which in this case is the master branch. For example, the user 102 such as Alice wants to add a search function to an e-commerce website. Alice will commit changes by creating a new branch. The new branch includes the commit made in the code to implement the new features. Alice then pushes the commits made in the source branch to the target branch to add the search function to the e-commerce website.

The user 102 generates the merge request 104 once the source branch is pushed to the target branch. The pushing employs the uploading of the commits made in the source branch to the target branch. The user 102 generates the merge request 104 by pushing. The merge request 104 includes merge request details that include the commit messages, file content, and diffs. The commit message is an annotation that a user 102 provides along with the name of the file and the context to which the changes are made. The commit messages provide short descriptions accompanying each commit. The commit messages can be made within the version control system 106. The commit message consists of a summary with a detailed description. The description includes details on why the commit is made, how it is implemented, and any other relevant details. For instance, Alex, a user 102, wants to implement a new feature for login within an application. The commit messages include a summary describing how the login feature works.

The file content includes information about the different files where the code changes occur to implement a feature to software or product. Moreover, the file content includes any new files that are being introduced as a part of merge request 104. For instance, the user 102 Alice wants to implement a new login feature. The changes in the code to implement the new login feature include changes in various file contents. Alice develops various files that can be saved under file content to implement the new login feature. All the files contain information about the code changes. typically, the various files include a file for the login feature which includes the code changes to merge the new login feature, a file for an authentication service that contains functions to communicate with the backend API 112 which includes information on the access token for each user 102, a readme file to include instructions on how the login feature is to be used. The access token contains information about Alice and the timeframe when she made the changes to the code.

The merge request diff provides a visual representation of the differences between codes in the source branch and target branch. The codes within the two branches are compared when the merge request 104 is created. The source branch includes the changes that have been made in the code to provide alterations. The target branch is the branch where changes are requested to be merged.

In operation 204, utilizing the database 110 to store the merge request details generated by the user 102 associated with the version control system 106.

The database 110 is coupled with the version control system 106. The database 110 stores the merge request details generated by the user 102. In at least one embodiment the database 110 is a GitLab repository. The user 102 can create multiple merge requests 104 which can be stored in the database 110. The database 110 is a virtual storage location that manages and tracks the changes made in the codes of the file of the project. The database 110 allows users 102 to work on the project at the same time. The database 110 stores the versions of the codes. The version of codes includes information on changes made within the code to implement features within the project. Moreover, the database 110 tracks the changes made to the file to build a history of the file with the corresponding timestamp.

The database 110 stores the commit messages of the merge request 104 using the commit objects. The commit objects include a snapshot of the codebase at a specific time and each codebase contains a commit message. Moreover, the commit objects include metadata about the user 102 and the timestamp. The database 110 also tracks the branch changes by keeping the history of the commits. The information includes where the code changes are coming from and to which branch the changes are received. The commit history includes a list of all the commits related to the merge request 104 along with basic information including the title of the commit, and a description of why the commit was made.

In operation 206, a code automation system 114 retrieves the merge request details from the database 110 via an application programming interface (API) 112.

The code automation system 114 is operatively coupled to the database 110. The code automation system 114 retrieves the merge request details from the database 110 via API 112. The API 112 is a set of rules and endpoints that allow retrieval of merge request details from the database 110. The code automation system 114 calls the API 112 to retrieve the merge request details. The API 112 passes the API key to authenticate the merge request details made by the user 102 on the version control system 106. Typically, to establish the connection between the database 110 and the code automation system 114, each user 102 has a personal access token with personal credentials. Once the API key is authenticated the merge request details and the merge request details are passed to the code automation system 114.

In at least one of the embodiments, the code automation system 114 retrieves the merge request details using the API 112 such as GitLab API. The GitLab API authenticates the access token of the user 102. The GitLab API retrieves the merge requests details. The GitLab API endpoint receives information using an HTTP GET request. The code automation system 114 then retrieves the merge request details. In at least one embodiment the merge request details can be in the JSON format. The code automation system 114 provides the fetched information from the database 110 to the prompt generator 116 to ensure consistent code quality control to prevent bugs.

In operation 208, a prompt generator 116 generates a first prompt to guide the AI engine 118 for generating code review comments 120.

The prompt generator 116 is integrated into the code automation system 114. The prompt generator 116 receives inputs from the code automation system 114. The merge request details are used to provide insights to the prompt generator 116. The prompt generator 116 provides the first prompts to guide the AI engine 118 to generate review code comments. In at least one embodiment, a prompt engineer generates a prompt structure along with the rules and guidelines to generate the first prompt. These rules and guidelines and the prompt structure are sent to the prompt generator 116, which executes a call function to retrieve the merge request details from the code automation system 114 and populates the prompt structure.

The first prompt guides the AI engine 118 to analyze the details of the merge request 104 code and provide feedback. The analysis of the details of the merge request 104 includes reviewing the code for code changes to generate code review comments 120. The code review is the act of checking the code for mistakes or problems. The code review comments 120 direct the problems and feedback related to the code. The problem includes the identification of bugs which includes different criteria to assess the code. The criteria include assessing the security issues, performance analysis, logic related to the code, and other changes that the user 102 makes while creating the merge request 104. The bugs define the errors or flaws within the code that produce incorrect or unexpected results. The bug errors include syntax errors which arise when the code is not aligned with the rules of the programming language and includes missing parentheses or semicolons.

The first prompt generated by the prompt generator 116 includes the assessment of the code quality in the changes made in the code of merge request details. The code quality is a measure of how well the code is written measures the accuracy and reliability of the code. The code should be easy to read and understand. The first prompts also include details to review the logic of the code. The first prompt guides the AI engine 118 to look for any logical errors in the code. For example, if the user 102 incorporates a feature to an application to calculate the total cost of items in a shopping cart. If the logic mistakenly adds the prices instead of multiplying the quantity by the price per item, the total will be incorrect, leading to potential issues at checkout.

The first prompt includes details for the AI engine 118 to assess changes in the codes for the security vulnerabilities. The vulnerabilities in the code are the weaknesses or flaws in the changed code that the attackers can exploit. The vulnerabilities enable unauthorized access, data breaches, system crashes, and other breaches. For example, the user 102 implements a new login feature to allow the end user to log in with a username and password. However, the code generated by user 102 can be easily manipulated by the attacker by tricking the system into bypassing the password and hacking the details of the account. This could allow the attacker to use sensitive data of the end user.

The first prompt also includes details to review the code for the performance. The code performance review focuses on the evaluation of how efficiently the code executes in terms of speed. For instance, for a code of 50 lines and a code of 10 lines performing the same task, the code performance of code for 10 lines is more efficient as the code executes in a faster manner than the longer length code.

The first prompts guide the AI engine 118 to provide feedback based on the review of the code. The feedback provides information on the bugs or errors found in the code. The problems can be security-related, performance-related, or logical errors within the code. The feedback is provided in the form of comments along with a recommendation on how to address the issue.

Below represents an exemplary first prompt by the prompt generator 116 to guide the AI engine 118 to review the code to generate the code review comments:
You are an AI code reviewer tasked with analyzing merge requests and providing feedback. Your goal is to identify potential issues related to security, performance, logic, or other problems in the code changes. Follow these instructions carefully:
1. Here is the merge request payload you will be working with:
   {merge_request_payload}//Code Change and Comments therto//
2. Follow these steps sequentially:
a. Fetch the merge request details:
Use this function call to retrieve the merge request details: <function_call> fetch_merge_request_details (merge_request_payload=merge_request_payload)</function call>
b. Review the ‘change’ field: If there were no errors in fetching the merge request details, examine the ‘change’ field in the returned data. Look for any issues related to security, performance, logic, or other potential problems. Use the ‘commit message’ and ‘file name’ fields for additional context.
c. Begin your output with “Feedback:” and use the following format:
   Feedback:
   Issue 1: [Describe the first issue]
   Recommendation: [Provide a recommendation to address the first issue]
   Issue 2: [Describe the second issue]
   Recommendation: [Provide a recommendation to address the second issue]
   [Continue this pattern for all identified issues]
   If no issues are found, output:
   Feedback: No issues found.
d. Add feedback as a comment:
If there were no errors in generating the feedback, use the following function to add it as a comment to the merge request: <function_call>add_comment_to_merge_request (merge_request_payload=merge_request_payload, comment=“[Insert your feedback here]”)</function_call>
3. Important guidelines:
   Do not assume anything. Only highlight issues for the functionality in the ‘change’ field.
   Always start your feedback with ‘Feedback:’.
   Provide recommendations for each issue you identify, and include a code snippet that demonstrates the solution to the issue (where possible).
   Add the comment to the merge request only once.
   Do not modify or extend the provided functions.
4. Error handling:
   If you encounter any errors or issues during the process, do not proceed with adding the comment.
   If there's an error in fetching merge request details or generating feedback, stop the process and report the error.
Remember to focus solely on the code changes provided in the ‘change’ field and use the available context to provide accurate and helpful feedback.

Prompt Explanation: The prompt guides the AI engine 118 to analyze merge request 104 and provide feedback. The AI engine 118 is required to carefully follow specific steps, including fetching merge request details, reviewing the change field for potential issues related to security, performance, logic, or other problems, and providing feedback in a specified format. The AI engine 118 adds the feedback as a comment to the merge request 104 and adheres to important guidelines such as not assuming anything, providing recommendations for identified issues, and handling errors appropriately.

In operation 210, the prompt generator 116 transfers the first prompt to guide the AI engine 118 to generate code review comments 120 such that the code review comments 120 address the code quality, performance, security, and maintainability of the code.

The generated first prompt is then transferred to the AI engine 118 which processes the first prompt to generate code review comments 120. The code review comments 120 aim to provide information on errors in the code the user 102 develops along with recommendations on how to fix the error.

The AI engine 118 is operatively coupled to the code automation system 114. The AI engine 118 validates the code written by the user 102. The AI engine 118 analyzes the context of the changes made by the user 102. The AI engine 118 utilizes machine learning algorithms to generate code review comments 120. The machine learning algorithms can understand code syntax, semantics, and context to identify potential issues. The machine learning algorithms analyze the code to identify errors in code syntax, semantics, and context. The code syntax refers to the rules that define the structure and organization of code in the programming language. The machine learning algorithms analyze the errors in the code using the historical data from past projects to predict potential bugs in the code changes of the merge request 104. The machine learning algorithms learn patterns from historical data.

In at least one embodiment, the AI engine 118 leverages AI libraries such as TensorFlow or PyTorch for machine learning tasks. TensorFlow is an open-source library for large-scale machine learning and deep learning models and algorithms. TensorFlow is owned by Google. Pytorch is a machine-learning library based on the Torch Library. Pytorch is owned by the Linux Foundation Umbrella.

The AI engine 118 analyzes the merge request details and provides code review comments 120 along with recommendations on how to fix the code.

Below represents an output generated by the AI engine 118 to provide code review comments 120 and recommendations to the user 102:

<CODE Snippet>
“php $updaterandomstring = $adb->pquery(′UPDATE crestel_updateorderstatus
SET status = ? WHERE status = ? AND order_number != ? ORDER BY id ASC LIMIT
?′, array($randomString, ′0′, ′′, 10));
</CODE Snippet>

AI Feedback:
Issue 1: Potential SQL Injection vulnerability in UpdateOrderStatus.service
Recommendation: In the file
‘cron/modules/BulkOrder/UpdateOrderStatus.service’, the SQL query is constructed using string concatenation, which can lead to SQL injection vulnerabilities. Instead, use parameterized queries to prevent this security risk. Here's an example of how to modify the code:
‘‘‘php
$updaterandomstring=$adb->pquery (‘UPDATE crestel_updateorderstatus SET status=? WHERE status=? AND order number!=? ORDER BY id ASC LIMIT?’, array ($randomString, ‘0’, ‘ ’, 10)); . . . ’’’
Issue 2: Inconsistent parameter passing in WsOrder.php
Recommendation: In the file ‘include/Webservices/WsBase/WsOrder.php’, the method ‘generateSalesInvoiceCall’ is called with two parameters, but its definition only accepts one parameter. Update the method definition to accept both parameters:

‘‘‘php
public function generateSalesInvoiceCall($invoiceId, $parentinvoicestatus) {
// ... existing code ...
}
’’’

Issue 3: Potential null pointer dereference in WsOrder.php
Recommendation: In the file ‘include/Webservices/WsBase/WsOrder.php’, there's a condition that checks if ‘$orderDetailsMap’ is not empty, but it's used before this check. Add a null check before using ‘$orderDetailsMap’ to prevent potential null pointer dereferences:

‘‘‘php
if (!in_array($order_type, $restrictedOrderType) && $flag == 2 &&
$orderDetailsMap !== null && !empty($orderDetailsMap)) {
// ... existing code ...
}
’’’

Issue 4: Inconsistent indentation in Edit.php
Recommendation: In the file ‘modules/Inventory/views/Edit.php’, the indentation is inconsistent. Use consistent indentation to improve code readability:

```
‘‘‘php
if ($simwithpin == 0) {
  $without_sim = ″1″;
}
} else {
  $simwithpin =
CrestelCommonUtils::getExternalResourceNumberForSIM($productid);
  $without_sim = ($simwithpin[′sim_type′]) ? ″″ : ″1″;
}
’’’
```

These changes will improve the security, consistency, and readability of the code. Please review and implement these recommendations.

Prompt Explanation: The AI engine 118 analyzes the merge request details to find any errors in the code. The AI engine 118 employs machine learning algorithms to find errors in the code. For example, the AI engine 118 analyzes a potential SQL injection vulnerability in the update order status service for which user 102 generates a merge request 104. The SQL injection vulnerability can allow attackers to gain access to sensitive data. The AI engine 118 provides feedback for vulnerabilities in the code. The feedback includes changes in the code to potentially avoid the attack by hackers.

In operation 212, the prompt generator 116 generates a second prompt to guide the AI engine 118 to generate test scenarios 122.

The code automation system 114 retrieves the merge request details to populate the prompt structure. The prompt generator 116 generates the second prompts to guide the AI engine 118 to develop test scenarios 122 for the code changes made by user 102. The test scenarios 122 outline the specific functionality or behavior of an application or software and describe a particular situation in which the functionality can be tested. For example, ‘Alice’ the user 102 generates merge request 104 for incorporating a new login feature in an application. The test scenarios 122 may include developing situations such as ‘enter user name and password’, click the login button. The expected results are that the end user is redirected to the dashboard page and a welcome message is displayed along with the end user's name.

In at least one embodiment, the prompt generator 116 such as prompt engineer generates a prompt structure along with the rules and guidelines to generate the second prompt. These rules and guidelines and the prompt structure are sent to the prompt generator 116, which executes a call function to retrieve the merge request details from the code automation system 114 and populates the prompt structure.

Below represents an exemplary second prompt by the prompt generator 116 for generating the test scenarios 122:
You are an AI assistant tasked with generating test scenarios for a merge request and adding them as
   a comment. Follow these instructions carefully:
   1. Here is the merge request payload you will be working with:
   {merge_request_payload}
   2. Follow these steps sequentially:
   a. Fetch the merge request details:
   Use this function call to retrieve the merge request details:
<function_call>fetch_merge_request_details (merge_request_payload=merge_reques t_payload)</function_call>
   b. Review the ‘change’ field:

If there were no errors in fetching the merge request details, Examine the ‘change’ field in the merge request details to identify test scenarios that cover:
Positive cases (expected inputs and behavior)
Negative cases (invalid inputs and error handling)
Edge cases (unusual or extreme inputs)
Performance considerations (if the changes could impact performance)
Compatibility with different environments or systems (if applicable)

Use the ‘commit_message’, ‘file_name’, and ‘file_content’ fields for additional context.
c. Begin your output with “Test Scenarios:” and use the following format:

### Test Scenarios:

Scenario 1: [scenario_1]
Expected Output: [expected_output]
Scenario 2: [scenario_2]
Expected Output: [expected_output]
[Continue this pattern for all scenarios]
   3. Add the test scenarios as a comment:

If there were no errors in generating the test scenarios, use the following function to add them as a comment to the
merge request. Ensure you add the comment only once:

<function_call>add_comment_to_merge_request(merge_request_payload=merge_reque
st_payload,comment=[Insert your generated test scenarios
here]”)</function_call>

### Important Notes:

Do not assume anything. Only generate test scenarios for the functionality in the ‘change’ field.
Always start your output with ‘Test Scenarios:’.
Add the comment to the merge request only once.
Do not modify or extend any functions provided to you.
   4. Error handling:
      If you encounter any errors or issues during the process, do not proceed with adding the comment.
      If there's an error in fetching merge request details or generating feedback, stop the process and
   report the error.
   Remember to focus solely on the code changes provided in the ‘change’ field and use the available
   context to provide accurate and helpful feedback.

In operation 214, the prompt generator 116 transfers the second prompt to guide the AI engine 118 to generate test scenarios 122 based on the merge request details where the test scenarios 122 include positive cases, negative cases, edge cases performance, and compatibility considerations. The generated second prompt is then transferred to the AI engine 118 which processes the second prompt to generate the test scenarios 122. The AI engine 118 processes the merge request details to generate the test scenarios 122. The AI engine 118 categorizes the test scenarios 122 into functional, non-functional, and edge cases using machine learning algorithms based on the merge request details.

The AI engine 118 categorizes the test scenarios 122 into functional test scenarios and non-functional test scenarios. The functional test scenarios focus on testing specific functionalities of the merge request 104 against the requirements. The functional test scenarios ensure that the code changes to implement a feature behave as expected and meet its specifications. The functional test scenarios can either include positive test cases or negative test cases. The positive test scenarios generally tests whether the implemented feature for which the merge request 104 is provided behaves as expected. For instance, if the code changes implement a new login feature, the positive test scenario will be when the end user can successfully log in with valid credentials. The negative test scenarios test if the software can handle invalid input or unexpected errors and does not crash or behave unpredictably. For instance, if the code changes implement a new login feature, the negative test scenario includes that when the end user enters incorrect credential details he/she cannot login into the application.

The non-functional test scenarios assess aspects of the merge request details that are not related to specific behaviors or functions which include performance, usability, security, and scalability. For example, the AI engine 118 generates scenarios that check the performance, usability, and security of the merge request 104 generated by the user 102. The performance test scenarios include how that application performs under a heavy load for which merge request 104 is generated. The heavy load can be when multiple end users are using the same application simultaneously. The usability test scenarios include the evaluation of the user interface 108 and whether the user interface 108 is easy to use or not. The security test scenarios include testing the application's response to various security threats, such as SQL injection or cross-site scripting (XSS). The non-functional test scenarios can also include positive test scenarios or negative test scenarios. The positive test scenarios involve verifying that the application performs well under normal conditions, such as load testing with an expected number of end users. The negative test scenarios involve assessing how the application handles extreme conditions or failures, such as testing for performance under excessive load or validating security measures against attacks.

The edge test scenarios target the extreme ends of input values or conditions to identify how the application or software behaves in unusual or boundary situations. The edge test scenarios help to ensure that the application handles edge cases gracefully. For instance, the user 102 implements a new login feature and generates merge request 104. The AI engine 118 generates test scenarios 122 which sets a minimum and maximum value input. The minimum value input includes testing the login feature with the shortest allowed username with 3 characters and the longest allowed username with 20 characters. The AI engine 118 utilizes machine learning algorithms to learn from the historical data to generate test scenarios 122 to ensure comprehensive coverage of both functional and quality aspects of an application. The AI engine 118 prioritizes the test scenarios 122 based on the perceived risk if code changes as identified by the AI engine 118.

Below represents an exemplary output of test scenarios 122 generated by the AI engine 118:

### Test Scenarios:

Scenario 1: Verify BRM data update without emailAddress field
Expected Output: BRM should successfully update the data without errors related to the emailAddress field.
Scenario 2: Check system functionality that previously used emailAddress
Expected Output: All system functionalities that previously relied on the emailAddress field should work correctly without it, or gracefully handle its absence.
Scenario 3: Verify data integrity for existing records
Expected Output: Existing records in the system should maintain their integrity, with no loss of email address data for records created before this change.
Scenario 4: Test customer creation process
Expected Output: New customers should be created successfully without the emailAddress field, and the process should not throw any errors related to missing email address.
Scenario 5: Test customer information retrieval
Expected Output: When retrieving customer information, the system should not attempt to fetch or display the email address, and should not produce any errors related to missing email address.
Scenario 6: Verify API responses
Expected Output: Any API responses that previously included the emailAddress field should now exclude it without causing issues for consuming services.
Scenario 7: Test search functionality
Expected Output: If there were any search features using the email address, they should be adjusted to work without this field or gracefully handle its absence.
Scenario 8: Verify logging and error handling
Expected Output: The system should not produce any errors or warnings related to the missing emailAddress field in logs or error reports.
Scenario 9: Test integration with other systems
Expected Output: Any integrations with external systems that previously relied on the emailAddress field should function correctly without it.

In operation 216, the AI engine 118 posts the generated code review comments 120 and test scenarios 122 back to the merge request 104 in the version control system 106. The AI engine 118 posts the generated code review comments 120 and test scenarios 122 on the user interface 108 of the version control system 106. The user 102 can further incorporate the changes provided by the AI engine 118 thus enhancing the code quality and coverage. After the analysis of the code and test scenario generation, the code automation system 114 automatically posts detailed code review comments 120 and suggested test scenarios 122 directly into the merge request 104. This integration facilitates immediate feedback to user 102, enabling them to make necessary adjustments or enhancements without delay.

The code automation system 114 allows the user 102 to focus on complex issues and strategic tasks by automating the initial stages of code review and test planning by speeding up the review process and also enhancing the collaboration among users by providing precise and actionable insights.

Below represents the pseudocode of the code management system 100 and code management process 200:
Initialize system with API keys and access tokens
Fetch merge request details
Analyze code using AI algorithms
Generate code review comments
Generate test scenarios
Post results back to the merge request

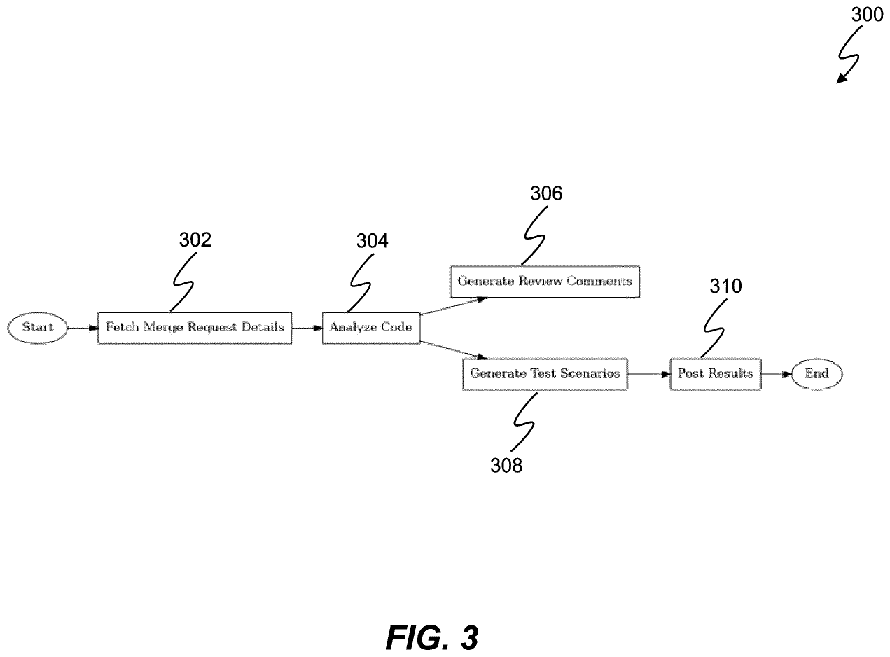

FIG. 3 depicts an exemplary review comment and test scenario generation process 300, which is an embodiment of the code management process 200 of FIG. 2. The review comment and test scenario generation process 300 generates code review comments 120 and test scenarios 122, respectively. Initially, the code automation system 114 fetches merge request details 302 which is generated by the user 102. The code automation system 114 populates the prompt structure. The prompt generator 116 generates the first and second prompts to guide the AI engine 118 to analyze code 304. The AI engine 118 utilizes machine learning algorithms to generate review comments 306 and generate test scenarios 308. The code automation system 114 then posts results 310 on the version control system 106.

For example, the user 102 submits merge request 104 for a search feature on the shopping application. The code automation system 114 fetches the merge request details. The AI engine 118 analyzes the code to generate review comment 306. The AI engine 118 analyzes that the code for the search feature has a syntax error and thus will lead to inefficiency while running the application. The AI engine 118 generates and posts results 310 on the version control system 106. The developer looks upon the errors enabling the developer to make necessary adjustments or enhancements without delay.

The AI engine 118 also generates test scenario 308 for the search feature. For instance, the test scenario for this new feature can be a positive scenario. If the end user searches mobiles on a shopping application, the end user will go to the result pages for mobile phones. The negative test scenario can be when the end user searches mobile phones, the result page will take the end user to some other accessories page. The AI engine 118 posts result 310 on the version control system 106. The developer looks at the test scenarios 122 and enables these test scenarios 122 to enhance the functionality of the application.

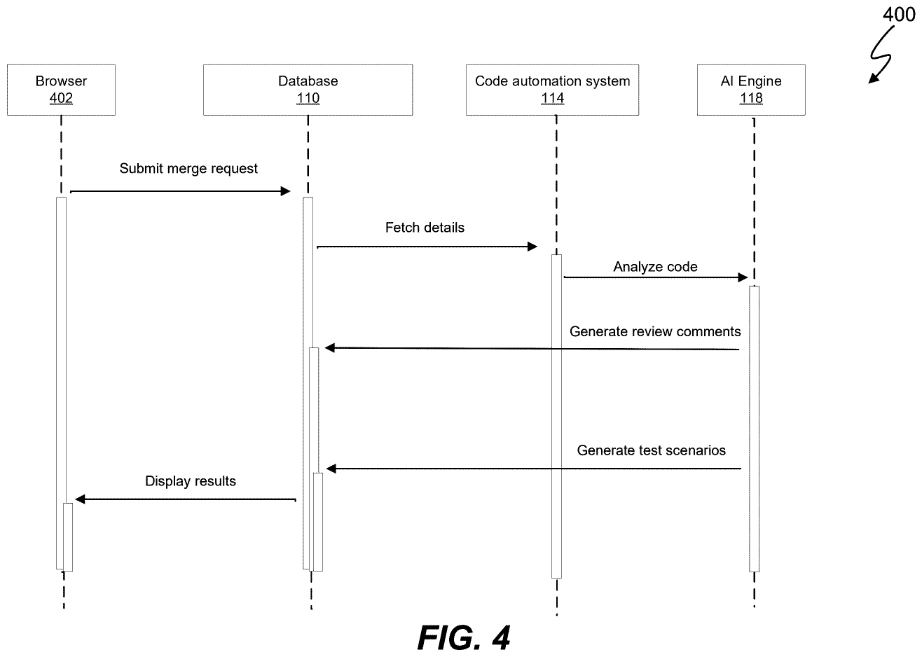

FIG. 4 depicts a sequence diagram 400 to display results on user interface 108 of version control system 106. The user 102 submits merge requests 104 using the browser 402 to access the version control system 106. The merge request 104 is received and stored in the database 110. The code automation system 114 fetches details from the database 110. The code automation system 114 populates the prompt structure. The prompt generator 116 generates the first and second prompt to guide the AI engine 118. The AI engine 118 analyzes the code. The AI engine 118 generates the code review comments 120 and the test scenarios 122. The database 110 stores the results. The stored generated code review comments 120 and the test scenarios 122 in the database 110 are displayed to the user 102 on the browser 402 on the user interface 108 of the version control system 106.

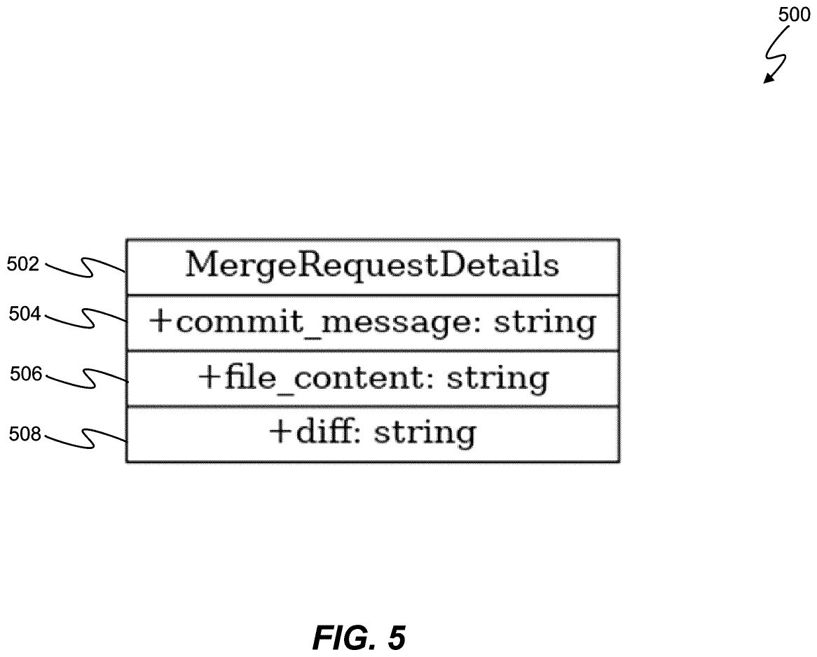

FIG. 5 depicts a data structure 500 for providing details of the merge request 104 for code review comments 120 and test scenarios 122 generation. The data structure 500 includes merge request details 502. The user 102 generates the merge request 104 which consists of the information relevant to the merge request 102. The merge request details 502 includes a plurality of components such as: commit message 504, file content 506, and diff 508.

The commit message 504 is used for storing the details of the commit message generated by the user 102. The commit message 504 includes a sequence of characters describing what change has been made in the code by the user 102. For example, the user 102 wants to add a new button in an application. The commit message string 504 includes the details provided by the user 102 along with the description of the button which in this case can be the deletion of entries within the table.

The file content 506 includes storing the details of the file in which the user 102 makes the changes in the code. The file content 506 includes a sequence of characters describing the changes made in the file that are being proposed to be merged. The diff 508 includes storing the details of the difference between the current state of the target branch and the source branch. The difference can be either additions, deletions, or modifications to the files.

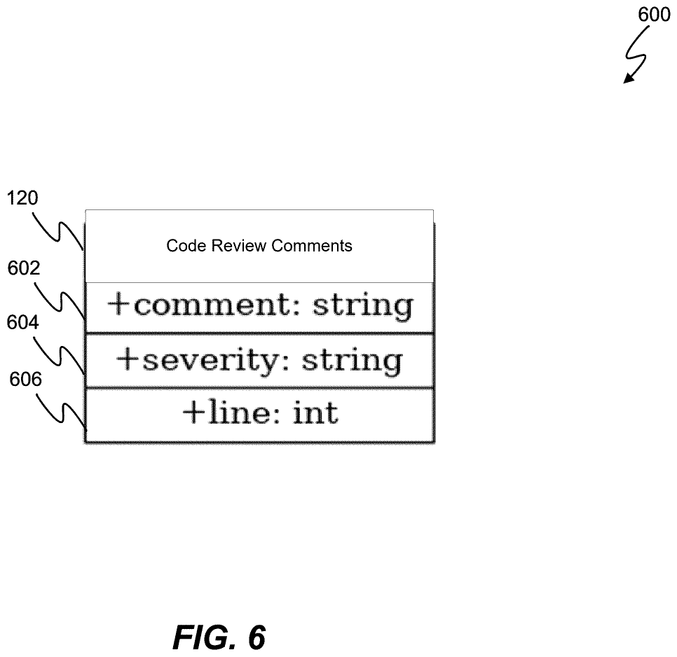

FIG. 6 depicts a data structure 600 to store the details of the AI-generated review comments during the code review process. The data structure 600 includes information on the code review comments 120 generated using AI engine 118. The code review comments 120 comprises a plurality of components such as: details of comments 602, severity 604, and line 606.

The comment 602 stores the comments generated by the AI engine 118 after analyzing the changes in the code made by user 102. The comment 602 includes a list of characters that help the user 102 make relevant changes to the code to enable the code to work efficiently. The comment 602 may include changes in the code such as syntax errors, spelling errors, security vulnerabilities, and so on. The severity 604 provides details about the impact of the defect on the functioning of the software. The severity 604 provides information on how severe the issue is and how critical it is to fix the issue. The severity 604 provides information on the urgency of the code that needs to be fixed. The line 606 indicates the line number for the code review comments 120 generated by the AI engine 118.

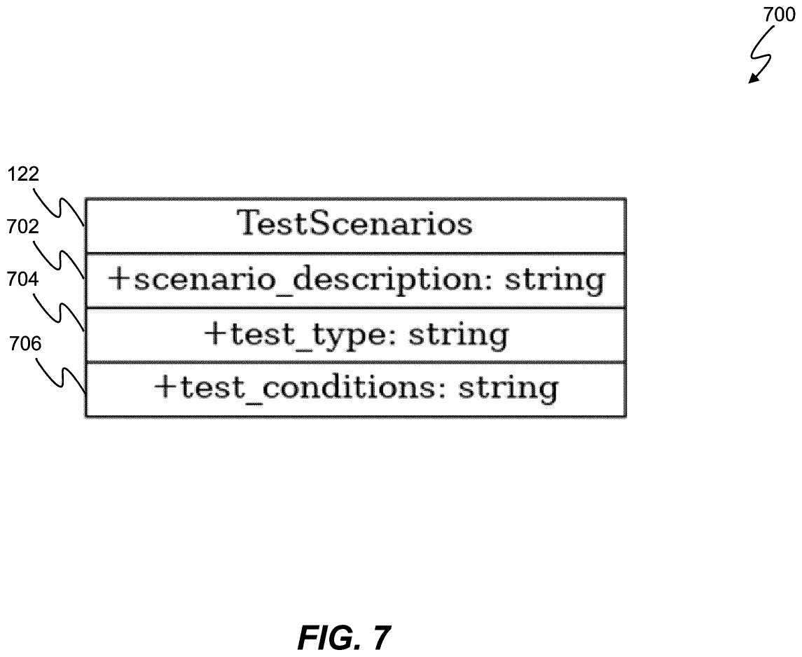

FIG. 7 depicts a data structure 700 to store the details of AI-generated test scenarios 122. The data structure 700 stores the details of test scenarios 122. The test scenario 122 comprises a plurality of components such as: scenario description 702, test type 704, and test conditions 706.

The scenario 702 describes a sequence of elements in which the application can be used for which the user 102 provides the code. For instance, the user 102 implements code to have a new ‘searching feature’ in the application. The test scenarios 122, in this case, can be ‘Verify whether the end user can search the right product’, ‘Verify if the end-user lands up on the product site he/she has searched for, and various others. The test type 704 includes a list of characters that verifies the software functionality, performance, and quality. The test type 704 can be classified into functional and non-functional testing. The functional testing ensures that the applications work expectedly. The non-functional testing focuses on how the application performs under various conditions. The test conditions 706 includes a list of characters that focus on individual features or aspects of the software.

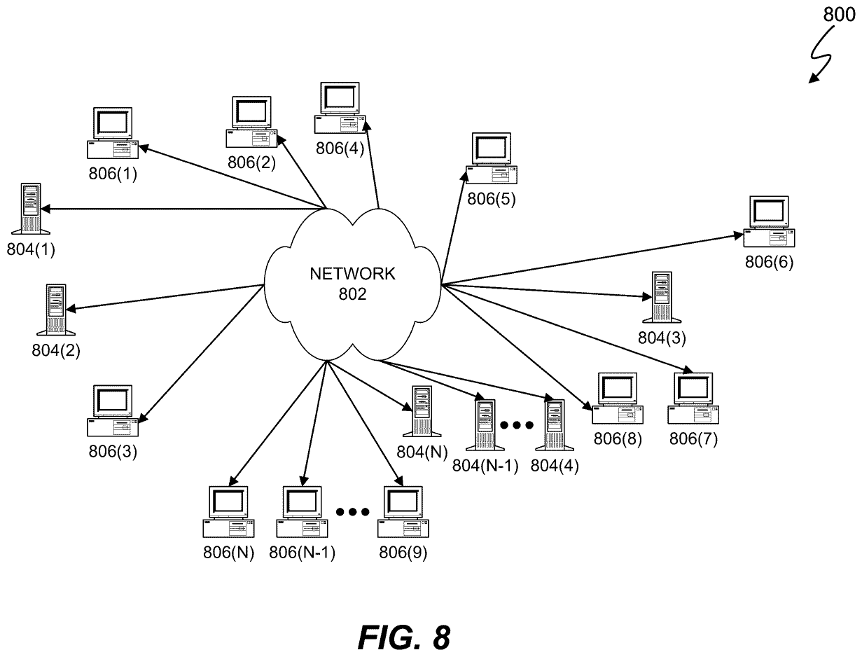

FIG. 8 is a block diagram illustrating a network environment in which a code management system 100 and code management process 200 may be practiced. Network 802 (e.g. a private wide area network (WAN) or the Internet) includes a number of networked server computer systems 804(1)-(N) that are accessible by client computer systems 806(1)-(N), where N is the number of server computer systems connected to the network. Communication between client computer systems 806(1)-(N) and server computer systems 804(1)-(N) typically occurs over a network, such as a public switched telephone network over asynchronous digital subscriber line (ADSL) telephone lines or high-bandwidth trunks, for example communications channels providing T1 or OC3 service. Client computer systems 806(1)-(N) typically access server computer systems 804(1)-(N) through a service provider, such as an internet service provider (“ISP”) by executing application specific software, commonly referred to as a browser, on one of client computer systems 806(1)-(N).

Client computer systems 806(1)-(N) and/or server computer systems 804(1)-(N) are specialized computer programmed to improve conventional computer systems to implement and utilize the code management system 100 and code management process 200. The type of computer system that can be specially programmed to implement and utilize the code management system 100 and code management process 200 include a mainframe, a mini-computer, a personal computer system including notebook computers, a wireless, mobile computing device (including personal digital assistants, smart phones, and tablet computers). These computer systems are typically designed to provide computing power to one or more users, either locally or remotely. Each computer system may also include one or a plurality of input/output (“I/O”) devices coupled to the system processor to perform specialized functions. Tangible, non-transitory memories (also referred to as “storage devices”) such as hard disks, compact disk (“CD”) drives, digital versatile disk (“DVD”) drives, and magneto-optical drives may also be provided, either as an integrated or peripheral device. In at least one embodiment, the code management system 100 and code management process 200 can be implemented using code stored in a tangible, non-transient computer readable medium and executed by one or more processors. In at least one embodiment, the code management system 100 and code management process 200 can be implemented completely in hardware using, for example, logic circuits and other circuits including field programmable gate arrays.

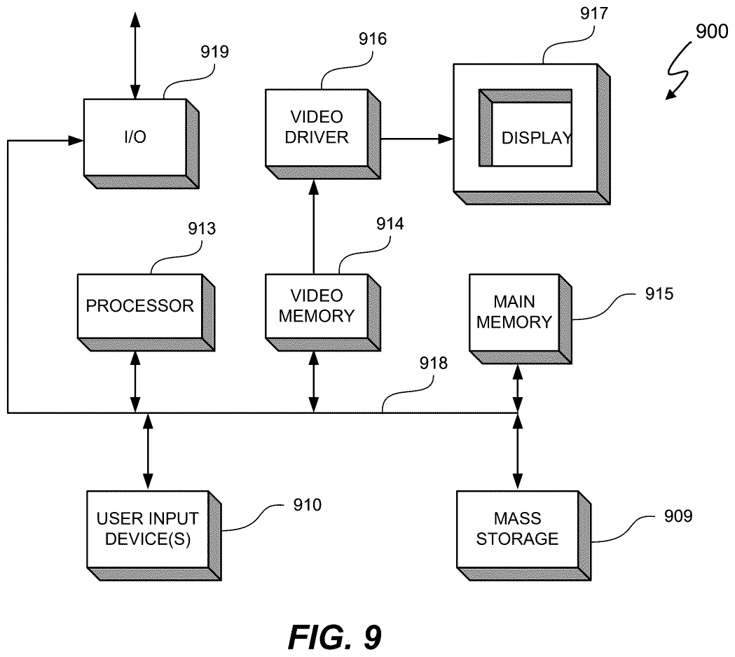

Embodiments of the code management system 100 and code management process 200 can be implemented on a computer system such as a special-purpose, special-programmed computer 900 illustrated in FIG. 9. Input user device(s) 910, such as a keyboard and/or mouse, are coupled to a bi-directional system bus 918. The input user device(s) 910 are for introducing user input to the computer system and communicating that user input to processor 913. The computer system of FIG. 9 generally also includes a non-transitory video memory 914, non-transitory main memory 915, and non-transitory mass storage 909, all coupled to bi-directional system bus 918 along with input user device(s) 910 and processor 913. The mass storage 909 may include both fixed and removable media, such as a hard drive, one or more CDs or DVDs, solid state memory including flash memory, and other available mass storage technology. Bus 918 may contain, for example, 32 of 64 address lines for addressing video memory 914 or main memory 915. The system bus 918 also includes, for example, an n-bit data bus for transferring DATA between and among the components, such as CPU 909, main memory 915, video memory 914 and mass storage 909, where “n” is, for example, 32 or 64. Alternatively, multiplex data/address lines may be used instead of separate data and address lines.

I/O device(s) 919 may provide connections to peripheral devices, such as a printer, and may also provide a direct connection to a remote server computer systems via a telephone link or to the Internet via an ISP. I/O device(s) 919 may also include a network interface device to provide a direct connection to a remote server computer systems via a direct network link to the Internet via a POP (point of presence). Such connection may be made using, for example, wireless techniques, including digital cellular telephone connection, Cellular Digital Packet Data (CDPD) connection, digital satellite data connection or the like. Examples of I/O devices include modems, sound and video devices, and specialized communication devices such as the aforementioned network interface.

Computer programs and data are generally stored as code in a non-transient computer readable medium such as a flash memory, optical memory, magnetic memory, compact disks, digital versatile disks, and any other type of memory. The computer program is loaded from a memory, such as mass storage 909, into main memory 915 for execution. “Memory” can be a single memory component or a collection of multiple memory components. Computer programs may also be in the form of electronic signals modulated in accordance with the computer program and data communication technology when transferred via a network. In at least one embodiment, Java applets or any other technology is used with web pages to allow a user of a web browser to make and submit selections and allow a client computer system to capture the user selection and submit the selection data to a server computer system.

The processor 913, in one embodiment, is a microprocessor manufactured by Motorola Inc. of Illinois, Intel Corporation of California, or Advanced Micro Devices of California. However, any other suitable single or multiple microprocessors or microcomputers may be utilized. Main memory 915 is comprised of dynamic random access memory (DRAM). Video memory 914 is a dual-ported video random access memory. One port of the video memory 914 is coupled to video amplifier 916. The video amplifier 916 is used to drive the display 917. Video amplifier 916 is well known in the art and may be implemented by any suitable means. This circuitry converts pixel DATA stored in video memory 914 to a raster signal suitable for use by display 917. Display 917 is a type of monitor suitable for displaying graphic images.

The computer system described above is for purposes of example only. The code management system 100 and code management process 200 may be implemented in any type of computer system or programming or processing environment. It is contemplated that the code management system 100 and code management process 200 might be run on a stand-alone computer system, such as the one described above. The code management system 100 and code management process 200 might also be run from a server computer systems system that can be accessed by a plurality of client computer systems interconnected over an intranet network. Finally, the code management system 100 and code management process 200 may be run from a server computer system that is accessible to clients over the Internet.

Although embodiments have been described in detail, it should be understood that various changes, substitutions, and alterations can be made hereto without departing from the spirit and scope of the invention as defined by the appended claims

What is claimed is:

1. A method for guiding an Artificial Intelligence (AI) engine for performing code review and generating test scenarios comprising:
executing code using one or more processors of a computer system to cause the computer system to perform operations comprising:
generating a merge request by a user on a user interface of a version control system, wherein the merge request includes merge request details including commit messages, file content, and diffs;
storing the merge request details generated by the user on a database associated with the version control system;
receiving by a code automation system the merge request details from the database via an Application programming interface (API);
generating a first prompt via a prompt generator to guide the AI engine for generating code review comments;
transferring the first prompt to the AI engine to analyze the retrieved merge request details to generate the code review comments, wherein the code review comments address at least one of code quality, performance, security, and maintainability;
generating a second prompt via the prompt generator to guide the AI engine for generating the test scenarios;
transferring the second prompt to the AI engine to generate the test scenarios based on the merge request details, wherein the test scenarios cover at least one of positive cases, negative cases, edge cases, performance, and compatibility considerations; and
posting the generated code review comments and test scenarios back to the respective merge request in the version control system.

2. The method of claim 1 wherein retrieving merge request details from GitLab database via a GitLab API.

3. The method of claim 1 wherein utilizing machine learning algorithms by the AI engine to analyze code syntax, semantics, and context to identify potential issues within the code review comments.

4. The method of claim 1 wherein categorizing the test scenarios into functional, non-functional, and edge case categories using machine learning algorithms utilized by the AI engine based on the analyzed merge request details.

5. The method of claim 1 wherein setting adjustable parameters for API for data retrieval, and managing variables required for the access of the database.

6. The method of claim 1 wherein identifying and generating recommendations related to coding standards specific to the programming language used in the merge request details.

7. The method of claim 1 wherein prioritizing test scenarios based on the perceived risk of code changes as identified by the AI engine.

8. The method of claim 1 wherein incorporating feedback by dynamically updating the AI engine by new code reviews and test scenarios submitted by the user over time.

9. A system for guiding an Artificial Intelligence (AI) engine for performing code review comments and generating test scenarios comprising:
one or more processors of a computer system;
memory, coupled to the one or more processors, that stores code and execution of the code by the one or more processors causes the computer system to perform operations comprising:
generating a merge request by a user on a user interface of a version control system, wherein the merge request includes merge request details including commit messages, file content, and diffs;
storing the merge request details generated by the user on a database associated with the version control system;
receiving by a code automation system the merge request details from the database via an Application programming interface (API);
generating a first prompt via a prompt generator to guide the AI engine for generating the code review comments;
transferring the first prompt to the AI engine to analyze the retrieved merge request details to generate the code review comments, wherein the code review comments address at least one of code quality, performance, security, and maintainability;
generating a second prompt via the prompt generator to guide the AI engine for generating the test scenarios;
transferring the second prompt to the AI engine to generate the test scenarios based on the merge request details, wherein the test scenarios cover at least one of positive cases, negative cases, edge cases, performance, and compatibility considerations; and
posting the generated code review comments and test scenarios back to the respective merge request in the database.

10. The system of claim 9 wherein retrieving merge request details from GitLab database via a GitLab API.

11. The system of claim 9 wherein utilizing machine learning algorithms by the AI engine to analyze code syntax, semantics, and context to identify potential issues within the code review comments.

12. The system of claim 9 wherein categorizing the test scenarios into functional, non-functional, and edge case categories using machine learning algorithms utilized by the AI engine based on the analyzed merge request details.

13. The system of claim 9 wherein setting adjustable parameters for API for data retrieval, and managing variables required for the access of the database.

14. The system of claim 9 wherein identifying and generating recommendations related to coding standards specific to the programming language used in the merge request details.

15. The system of claim 9 wherein prioritizing test scenarios based on the perceived risk of code changes as identified by the AI engine.

16. The system of claim 9 wherein incorporating feedback by dynamically updating the AI engine by new code reviews and test scenarios submitted by user over time.
